(19) United States
(12) Patent Application Publication
(10) Pub. No.: US 2017/0330401 A1
(43) Pub. Date: Nov. 16, 2017

(54) LOGIN SETTING METHOD AND SYSTEM FOR AN ELECTRIC LOCK

(71) Applicant: WFE TECHNOLOGY CORP., Taichung City (TW)

(72) Inventor: Jack LIEN, Taichung City (TW)

(73) Assignee: WFE TECHNOLOGY CORP., Taichung City (TW)

(21) Appl. No.: 15/156,295

(22) Filed: May 16, 2016

(51) Int. Cl. G07C 9/00

(52) U.S. Cl. CPC G07C 9/00309; G07C 2009/00388

(57) ABSTRACT

An electric lock login setting method includes: a first detection step: using a verification card to detect a detection unit of an electric lock; a learning pairing step: the electric lock stepping into a learning pairing mode so as to communicate an electronic device with the electric lock via a wireless signal, thereby setting pairing between the electronic device with the electric lock; and a second detection step: after setting pairing between the electronic device with the electric lock, using the verification card to detect the detection unit of the electric lock again so as to finishing setting login of the electronic device relative to the electric lock such that the electronic device is authorized to detect the detection unit to activate a control device to unlock the electric lock.

### BACKGROUND OF THE INVENTION

### 1. Field of the Invention

The present invention relates generally to a login setting method for an electric lock, and more particularly to an electric lock login setting method and system, in which a verification card is used twice in order to finish the login setting of the electric lock and the system.

### 2. The Prior Arts

Due to rapid development of the society and boom of the industrial business, majority of people today become well to do and hence to protect their life and property become an important issue we are facing today. Since the government is unable to sustain and provide a lesser crime environment, most people rely on safety locks and/or iron windows to protect their belongings and hence there are a plurality of safety locks available in the market, one of them is an electric lock much prefer to and upon which the reliability thereof is increasing day by day.

However, of late the electronic technology of today has invented some electric locks, such as electric locks operable by a key card and/or an IC (Integrated Circuit) card and/or RFID (Radio-frequency identification) card such that whenever the user wants to unlock or open the door installed with electric lock, the user must always carry the key card and/or RFID card, thereby causing inconvenience to the user. In addition, in order to enable the key card and/or RFID card to unlock the electric locks, login settings should be conducted on the electric locks. It is noted that during login settings of the electric locks, a would-be intruder may have the chance of copying the login settings via some tools, hence setting of the key card and/or RFID card relative to the electronic locks remain doubts, whether this kind of login setting method for the electric locks is sufficiently safe.

Therefore, the inventor has noticed that the login settings of the key card and/or RFID card relative to the electric locks is inconvenient and needs to be improved in order to eliminate the occurrence of the above-stated drawbacks.

### SUMMARY OF THE INVENTION

A primary objective of the present invention is to provide a system and an electric lock login setting method, in which a verification card is used twice in order to offer the outmost anti-theft function.

To achieve the objective, a method for login setting an electric lock according to the present invention includes: (i) a first detection step: using a verification card to detect the electric lock; and (ii) a learning pairing step: after the first detection step, the electric lock stepping into a learning pairing mode so as to communicate an electronic device with the electric lock via a wireless signal, thereby setting pairing between the electronic device with the electric lock so as to finishing setting login of the electronic device relative to the electric lock such that the electronic device is authorized to unlock the electric lock. Of course, in order to protect the electric lock from being detected by another electronic device (like smart phone of other person), a second detection step is applied, in which, after conducting the learning pairing step, the electric lock will transmit a confirmation message to the electronic device or the electric lock displays the confirmation message, in form of a voice message like “finishing pairing”, thereby using the verification card to detect the electric lock again and hence ensuring login setting of the electric lock.

To achieve the objective, a method for login setting an electric lock according to the present invention includes: (i) a first detection step: using a verification card to detect the electric lock; (ii) a learning pairing step: after the first detection step, the electric lock stepping into a learning pairing mode so as to communicate an electronic device with the electric lock via a wireless signal, thereby setting pairing between the electronic device with the electric lock; and (iii) an authenticating and pairing step. The authenticating and pairing step is conducted in the following manner, (i) the electric lock transmits an indicating message to the electronic device so as to input an authenticating message corresponding to the indicating message such that electronic device is electronically paired with the electric lock if the authenticating message matches with the indicating message such that the electronic device is authorized to unlock the electric lock. Of course, in order to protect the electric lock from being detected by another electronic device (like smart phone of other person), a second detection step is applied, in which, after conducting the authenticating and pairing step, the electric lock will transmit a confirmation message to the electronic device or the electric lock displays the confirmation message, in form of a voice message like “finishing pairing”, thereby using the verification card to detect the electric lock again and hence ensuring login setting of the electric lock.

An electric lock login setting system according to the present invention includes a verification card and an electric lock installed on a door. The electric lock includes a detection unit, a wireless communication unit, an operating module and a control device, wherein the operating module is electrically connected to the detection unit while the wireless communication unit is electronically connected to the control device such that the verification card is used for detecting the detection unit while the operating module turns into a learning and pairing mode, where an electronic device communicate with the electric lock via a wireless signal so as to electronically pairing the electronic device with the electric lock, after which, the verification card is used again to detect the detection unit so as to authenticate login setting of the electronic device relative to the electric lock, thereby allowing the electronic device to detect the electric lock such that the operating module drives and activates the control device, thereby unlocking the electric lock.

In the system and the electric lock login setting method of the present invention, a Bluetooth-enabled smart phone and the electric lock system are applied while the electric lock is detected twice by a verification card so as to ensure login setting of the electric lock to provide double anti-theft function, there by preventing unlocking of the electric by other smart phone.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a block diagram of a method for login setting an electric lock according to a first embodiment of the present invention;

FIG. 2 is a block diagram of a method for login setting an electric lock according to a second embodiment of the present invention;

FIG. 3 is a block diagram of a method for login setting an electric lock according to a third embodiment of the present invention;

FIG. 4 is a block diagram of a method for login setting an electric lock according to a fourth embodiment of the present invention;

FIG. 5 shows a block diagram representing an electric lock login setting system of the present invention;

FIG. 6 illustrates the electric lock login setting system of the present invention installed on a door; and

FIG. 7 illustrates the electric lock login setting system of the present invention installed on a door in application.

### DETAILED DESCRIPTION OF THE PREFERRED EMBODIMENTS

The accompanying drawings are included to provide a further understanding of the invention, and are incorporated in and constitute a part of this specification. The drawings illustrate embodiments of the invention and, together with the description, serve to explain the principles of the invention.

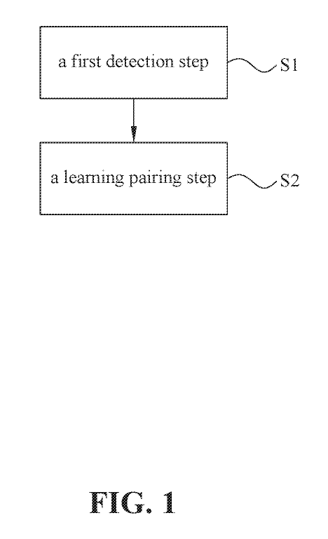

FIG. 1 is a block diagram of a method for login setting an electric lock according to a first embodiment of the present invention. As shown, the method for login setting an electric lock includes the following steps.

A first detection step S1: using a verification card 20 to detect the electric lock 10. In this embodiment, an IC (Integrated Circuit) card or RFID (Radio-frequency identification) card is used as the verification card 20 to detect the electric lock 10 wirelessly.

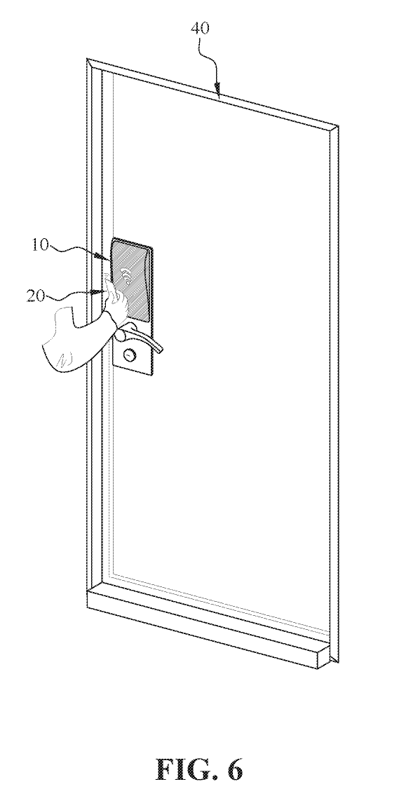

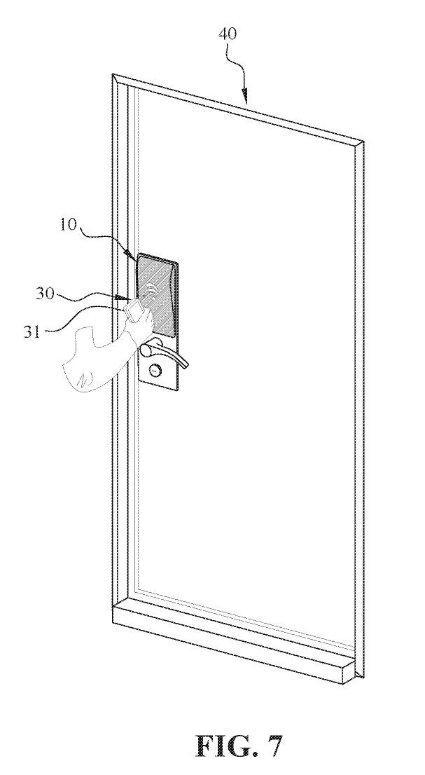

A learning pairing step S2: as shown in FIGS. 6 and 7, after the first detection step S1, the electric lock 10 steps into a learning pairing mode so as to communicate an electronic device 30 with the electric lock 10 via a wireless signal, thereby setting pairing between the electronic device 30 with the electric lock 10 so as to establish setting login of the electronic device 30 relative to the electric lock 10 such that the electronic device 30 is authorized to unlock the electric lock 10. In other words, after the present step, the electric lock 10 can be opened at any desired time after the same is detected by the electronic device 30. In this embodiment, a smart phone 31 or a Tablet can serve as the electronic device 30 for wirelessly communicated with the electric lock 10 via Bluetooth, Zigbee or Zi-Wave protocols.

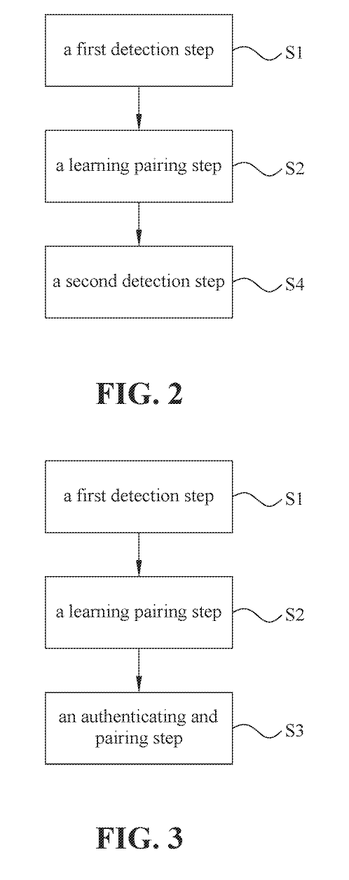

FIG. 2 is a block diagram of a method for login setting an electric lock according to a second embodiment of the present invention. The second embodiment is similar to the above-mentioned embodiment, but further includes the following step.

A second detection step S4: after setting pairing between the electronic device 30 with the electric lock 10, using the verification card 20 to detect the electric lock 10 again so as to establish setting login of the electronic device relative to the electric lock such that the electronic device 30 is authorized to unlock the electric lock 10.

Therefore, in order to protect the electric lock 10 from being detected by the other smart phone 31, the second detection step S4 is applied such that after the learning pairing step S2, the electric lock 10 transmits a confirmation message to the electronic device 30 or the electric lock 10 displays the confirmation message thereon, in form of a voice message like “finishing pairing”, thereby using the verification card 20 to detect the electric lock 10 again, as best shown in FIG. 6, and hence ensuring login setting of the electric lock 10. In other words, after the learning pairing step S2, if the electronic device 30 does not receive any confirmation message from the electric lock 10 within a specific time interval or the electric lock 10 does not display any confirmation message, one can judge that the electric lock 10 is electronically paired to the non-targeted electronic device. Hence, no second time detection of the verification card 20 relative to the electric lock 10 is required to be conducted in order to protect the electric lock 10 from being opened by the non-targeted electronic device.

Generally, during the learning pairing step S2, the electric lock 10 may emit specific lighting informing the user that login setting process should be completed before diminishing of the lighting. If such case occurs and the user finds that the electronic device does not receive any conformation message from the electric lock 10 or the electric lock 10 does not display any confirmation message thereon, he must not use the verification card 20 to detect the electric lock 10 for the second time, but should wait the lighting dies out. After which, he should do the first detection step S1 and the learning pairing step S2 again until the electronic device 30 receives the confirmation message from the electric lock 10 or the electric lock 10 displays the confirmation message thereon, in form of a voice message, like “finishing pairing and detect for a second time”, where the user can conduct the second detection step S4 using the verification card 20 to detect the electric lock 10 again and hence ensuring the login setting between the electronic device 30 relative to the electric lock 10.

FIG. 3 is a block diagram of a method for login setting an electric lock according to a third embodiment of the present invention. The third embodiment is similar to the first embodiment, but further includes the following step.

An authenticating and pairing step S3: the electric lock 10 transmits an indicating message so as to input an authenticating message corresponding to the indicating message such that electronic device 30 is electronically paired with the electric lock 10 if the authenticating message matches with the indicating message, thereby establishing setting login of the electronic device 30 relative to the electric lock 10 such that the electronic device 30 is authorized to unlock the electric lock 10. To be more specific, after the learning pairing step S2, in order to ensure login setting procedure, the authenticating and pairing step can be conducted in the following manner, (i) the electric lock 10 transmits an indicating message wirelessly to the target electronic device 30, as best shown in FIG. 7. For instance, the target electronic device 30 is a smart phone 31 while the indicating message is “123”. If the user sees “123” in his smart phone 31, he can input an authenticating message “123” corresponding to the indicating message into the electric lock 10. The electric lock upon sensing the input message “123” the same as it has transmitted previously, thereby ensuring the electric lock 10 is electronically paired with the smart phone 31. Alternately, the electric lock 10 transmits an indicating message, in form of voice message where “456” is broadcasted, the user inputs “456” into his smart phone 31 upon hearing broadcast of “456”, which in turn, is transmitted wirelessly to the electric lock 10. Finally, when the authenticating message “456” matches with the indicating message “456”; the smart phone 31 is electronically paired with the electric lock 10.

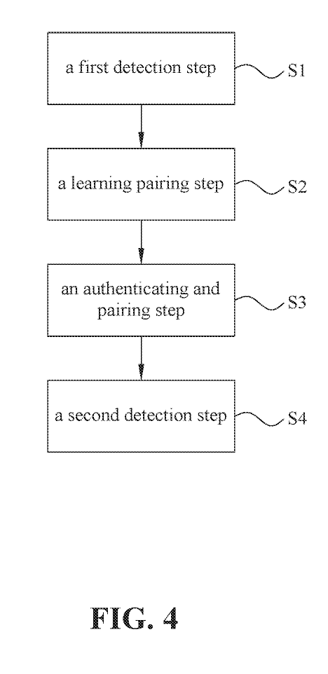

FIG. 4 is a block diagram of a method for login setting an electric lock according to a fourth embodiment of the present invention, which is similar to the third embodiment, but further includes the following step.

A second detection step S4: after setting pairing between the electronic device 30 with the electric lock 10, using the verification card 20 to detect the electric lock 10 again so as to establish setting login of the electronic device 30 relative to the electric lock 10 such that the electronic device 30 is authorized to unlock the electric lock 10.

As illustrated in the third embodiment of the present invention, after the user has inputted the authenticating message “123” into the electric lock 10 so as to ensure pairing of the electronic device 30 relative to the electric lock 10, the latter transmits a confirmation message to the electronic device 30 or the electric lock 10 displays the confirmation message thereon, as best shown in FIG. 6, in which, the verification card 20 is used again to detect the electric lock 10, and hence ensuring login setting of the electric lock 10. Alternately, in the third embodiment, when the electric lock 10 transmits an indicating message, in form of voice message where “456” is broadcasted, it is possible that a third person nearby may overhear the message and that he may input “456” into a non-targeted smart phone 31 upon overhearing broadcast of “456” rather than the target smart phone. Under this condition, the smart phone 31 of the third person is electronically paired with the electric lock 10. To prevent occurrence of such incident, the authenticating and pairing step S3 has been proposed after the second detection step S4 according the present invention so that in case the user of the target electronic device finds out the electric lock 10 displays a confirmation message before he has inputted the authenticating message “456” into the target electronic device 30, he can understand that an intruder has his non-target electronic device login setting with the electric lock 10. So he needs not conduct the second detection step using the verification card 20 so to prevent the intruder unlocking the electric lock 10 by the non-target electronic device. In the event that the user of the target electronic device 32 has transmitted the authenticating message “456” and finds that no confirmation message is fed back from the electric lock 10 or the electric lock 10 displays no confirmation message, the user of the target electronic device does not need to conduct the second detection step relative to the electric lock 10 using his verification card 20. Hence, the distinct feature of the present invention resides in using the verification card 20 to conduct the second detection step in order to ensure login setting of the electronic device relative to the electric lock.

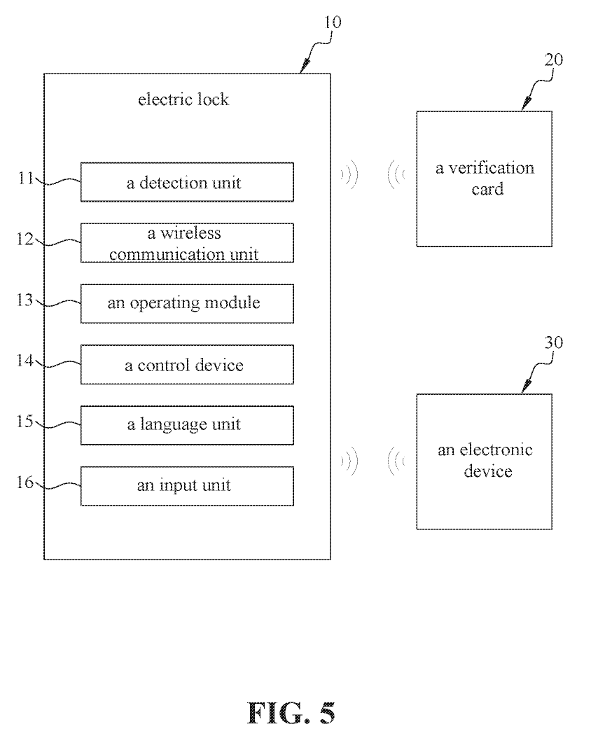

Referring to FIGS. 3 and 5, an electric lock login setting system according to the present invention includes a verification card 20 and an electric lock 10 installed on a door.

The electric lock 10 includes a detection unit 11, a wireless communication unit 12, an operating module 13 and a control device 14, wherein the operating module 13 is electrically connected to the detection unit 11 while the wireless communication unit 12 is electronically connected to the control device 14 such that the verification card 20 is used for detecting the detection unit 11 while the operating module 13 turns into a learning pairing mode, where the electric lock 10 emits some specific lighting informing the user that login setting process of the smart phone 31 relative to the electric lock 10 should be completed before diminishing of the lighting. Preferably, an IC (Integrated Circuit) card or RFID (Radio-frequency identification) card is used for the verification card 20 to detect the electric lock 10 wirelessly.

As best shown in FIG. 7, the smart phone 31 of the user communicates wirelessly with the wireless communication unit 12 so as to electronically pairing the smart phone 31 with the electric lock 10, wherein the wireless communication unit 12 utilizes Bluetooth, Zigbee or Zi-Wave protocols. After the above pairing step, the smart phone 31 can detect the electric lock 10 such that the operating module 13 drives and activates the control device 14, thereby unlocking the electric lock 10.

Of course, as described in the second embodiment of the login setting an electric lock, to protect and to ensure that the electric lock 10 cannot be detected by a smart phone 31 of a third person, the electric lock 10 transmits a confirmation message to the electronic device 30 or the electric lock 10 displays the confirmation message thereon, in form of a voice message like “finishing pairing”, thereby using the verification card 20 to detect the electric lock 10 again, as best shown in FIG. 6, and hence ensuring login setting of the electric lock 10. In other words, after the operating module 13 steps into the learning pairing step and if the smart phone 31 does not receive any confirmation message from the electric lock 10 within a specific time interval or the electric lock 10 does not display any confirmation message, the user can judge that the electric lock 10 is electronically paired to the non-targeted smart phone 31. Hence, no second time detection of the verification card 20 relative to the electric lock 10 is required to be conducted in order to protect the electric lock 10 from being opened by the non-targeted smart phone 31.

As best shown in FIGS. 3 and 5, the electric lock login setting system according to the present invention further includes a language unit 15 and an input unit 16 respectively connected to the operating module 13.

In the electric lock login setting method of the third embodiment, during setting pairing of the smart phone 31 relative the electric lock 10, in order to ensure login setting procedure, the login setting procedure can be conducted in the following manner, (i) the electric lock 10 transmits an indicating message wirelessly to the target smart phone 31, for instance, the indicating message is “123”. If the user sees “123” in his smart phone 31, he can input an authenticating message “123” corresponding to the indicating message into the electric lock 10. The electric lock upon sensing the input message “123” the same as it has transmitted previously, thereby ensuring the electric lock 10 is electronically paired with the smart phone 31. Alternately, the electric lock 10 transmits an indicating message, in form of voice message where “456” is broadcasted, the user inputs “456” into his smart phone 31 upon hearing broadcast of “456”, which in turn, is transmitted wirelessly to the electric lock 10. When the authenticating message “456” matches with the indicating message “456”; the smart phone 31 is electronically paired with the electric lock 10. In the succeeding times, in case the user detect the electric lock 10 using his smart phone 31, the operating module 13 activates the control device 14 to unlock the electric lock 10. In the electric lock login setting method of the fourth embodiment, during setting pairing of the smart phone 31 relative the electric lock 10, the electric lock 10 will transmit a confirmation message to the smart phone 31, in form of a voice message like “finishing pairing”, thereby using the verification card 20 to detect the electric lock 10 again and hence ensuring login setting of the electric lock 10.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A method for login setting an electric lock comprising the steps of:
(i) a first detection step: using a verification card to detect the electric lock;
(ii) a learning pairing step: after the first detection step, the electric lock stepping into a learning pairing mode so as to communicate an electronic device with the electric lock via a wireless signal, thereby setting pairing between the electronic device with the electric lock; and
(iii) a second detection step: after setting pairing between the electronic device with the electric lock, using the verification card to detect the electric lock again so as to establish setting login of the electronic device relative to the electric lock such that the electronic device is authorized to unlock the electric lock.

2. The login setting method according to claim 1, wherein after the learning pairing the electronic device relative to the electric lock, the electric lock transmits a confirmation message to the electronic device or the electric lock displaying the confirmation message thereon.

3. A method for login setting an electric lock comprising the steps of:
(i) a first detection step: using a verification card to detect the electric lock;
(ii) a learning pairing step: after the first detection step, the electric lock stepping into a learning pairing mode so as to communicate an electronic device with the electric lock via a wireless signal, thereby setting pairing between the electronic device with the electric lock;
(iii) an authenticating and pairing step: the electric lock transmitting an indicating message so as to input an authenticating message corresponding to the indicating message such that electronic device is electronically paired with the electric lock if the authenticating message matches with the indicating message; and
(iv) a second detection step: after authenticating setting pairing between the electronic device with the electric lock, using the verification card to detect the electric lock again so as to establish login setting of the electronic device relative to the electric lock such that the electronic device is authorized to unlock the electric lock.

4. The login setting method according to claim 3, wherein after the authenticating and pairing the electronic device relative to the electric lock, the electric lock transmits a confirmation message to the electronic device or the electric lock displaying the confirmation message thereon.

5. The login setting method according to claim 3, wherein in the authenticating and pairing step, the electric lock transmits the indicating message so as to input the authenticating message corresponding to the indicating message to the electronic device such that electronic device is electronically paired with the electric lock if the authenticating message matches with the indicating message.

6. The login setting method according to claim 3, wherein in the authenticating and pairing step, the electric lock transmits the indicating message so as to input an authenticating message corresponding to the indicating message to the electronic device such that electronic device is electronically paired with the electric lock if the authenticating message matches with the indicating message.

7. The login setting method according to claim 6, wherein in the authenticating and pairing step, the indicating message and the authenticating message respectively are a voice message and a string of coded words.

8. An electric lock login setting system comprising:
a verification card; and
an electric lock installed on a door, including a detection unit, a wireless communication unit, an operating module and a control device, wherein the operating module is electrically connected to the detection unit while the wireless communication unit is electronically connected to the control device such that the verification card is used for detecting the detection unit while the operating module turns into a learning and pairing mode, where an electronic device communicate with the electric lock via a wireless signal so as to electronically pairing the electronic device with the electric lock, after which, the verification card is used again to detect the detection unit so as to authenticate login setting of the electronic device relative to the electric lock, thereby allowing the electronic device to detect the electric lock such that the operating module drives and activates the control device, thereby unlocking the electric lock.
